(19) United States
(12) Patent Application Publication
(10) Pub. No.: US 2024/0222661 A1
(43) Pub. Date: Jul. 4, 2024

(54) A FUEL CELL SYSTEM, A METHOD OF CONTROLLING A FUEL CELL SYSTEM, AND A VEHICLE COMPRISING A FUEL CELL SYSTEM

(71) Applicant: VOLVO TRUCK CORPORATION, Göteborg (SE)

(72) Inventors: Tove AUDHAV, Landvetter (SE); Fredrik RAHM, Hörby (SE)

(73) Assignee: VOLVO TRUCK CORPORATION, Göteborg (SE)

(21) Appl. No.: 18/560,755

(22) PCT Filed: May 20, 2021
(86) PCT No.: PCT/EP2021/063537

§ 371 Date: Nov. 14, 2023

(51) Int. Cl. H01M 8/04014; H01M 8/04111; H01M 8/0432; H01M 8/04746

(52) U.S. Cl. CPC H01M 8/04014; H01M 8/04111; H01M 8/04335; H01M 8/04761; H01M 2250/20

(57) ABSTRACT

A fuel cell system is for a vehicle at least partially propelled by an electric traction motor. The fuel cell system includes a fuel cell comprising an anode side and a cathode side, an expander connected to a fuel cell motor, an inlet conduit connected to an inlet end of the cathode side for supply of air to the cathode side, an outlet conduit connected between an outlet end of the cathode side and an inlet side of the expander for supply of an exhaust flow from the cathode side to the expander, and an exhaust conduit connected to an exhaust side of the expander, and a heat exchanger connected at the inlet conduit and at the exhaust conduit for transfer of heat between the inlet conduit and the exhaust conduit.

### TECHNICAL FIELD

The present invention relates to a fuel cell system for a vehicle at least partially propelled by an electric traction motor. The present invention also relates to a method of controlling a fuel cell system, and a vehicle comprising such a fuel cell system. Although the invention will mainly be directed to a vehicle in the form of a truck using a fuel cell for generating electric power to an electric traction motor, the invention may also be applicable for other types of vehicles using a fuel cell system for generating electric power, such as e.g. a hybrid vehicle comprising an electric machine as well as an internal combustion engine for propulsion.

### BACKGROUND

The propulsion systems of vehicles are continuously developed to meet the demands from the market. A particular aspect relates to the emission of environmentally harmful exhaust gas. Therefore, other more environmentally friendly alternatives compared to a conventional internal combustion engine are evaluated and implemented in vehicles. A preferred alternative is the use of one or more electric machines for propelling the vehicle.

In order to generate the electric power for operating the electric machine(s), fuel cell arrangements are one of the preferred alternatives. According to an example, the fuel cell arrangement may comprise a fuel cell stack in which an electrochemical reaction of hydrogen and oxygen generates electric power. The fuel cell stack comprises an anode side in which hydrogen is supplied, and a cathode side in which air is supplied.

The air entering the cathode side should preferably be controlled to have a certain temperature for the fuel cell to function as desired. However, controlling the air temperature requires an energy consuming process. It is therefore a desire to be able to deliver air to the intake side of the cathode in a way that is less energy consuming and in turn beneficial for the vehicle system efficiency and vehicle performance, as well as to increase the power density of a fuel cell arrangement.

### SUMMARY

It is thus an object of the present invention to at least partially overcome the above described deficiencies.

According to a first aspect, there is provided a fuel cell system for a vehicle at least partially propelled by an electric traction motor, the fuel cell system comprising a fuel cell comprising an anode side and a cathode side, an expander connected to a fuel cell motor, an inlet conduit connected to an inlet end of the cathode side for supply of air to the cathode side, an outlet conduit connected between an outlet end of the cathode side and an inlet side of the expander for supply of an exhaust flow from the cathode side to the expander, and an exhaust conduit connected to an exhaust side of the expander, and a heat exchanger connected at the inlet conduit and at the exhaust conduit for transfer of heat between the inlet conduit and the exhaust conduit.

The expander should be understood as being a component arranged to expand the exhaust flow from the outlet end of the cathode side of the fuel cell. The expander may, according to an example embodiment, be a turbine. As an alternative, the expander may be a piston expander. Other further alternatives are also conceivable, such as e.g. a root expander or a scroll expander.

The fuel cell motor should be construed as a motor connected to the fuel cell. The wording should thus not be interpreted as the motor being a fuel cell. Further, the exhaust flow from the cathode side may contain air, water, hydrogen, or any combination thereof.

The present invention is based on the insight that the temperature level downstream the expander is lower compared to a position upstream the expander. The inventors have unexpectedly realized that the temperature level downstream the expander can be advantageously heat transferred to the inlet end of the cathode side of the fuel cell. An advantage is that an increased heat transfer is provided when heat is shifted from the inlet conduit to the exhaust conduit, whereby less auxiliary cooling power is required.

The fuel cell system thus enables heat transfer between the inlet end of the cathode side and the outlet end of the cathode side, thereby improving the overall system efficiency. The exhaust flow from the outlet end of the cathode side can be used to change the temperature of the inlet flow of the cathode side towards a wanted temperature value. The fuel cell system can hereby be used both for cooling and heating depending on the initial temperature at the inlet side.

According to an example embodiment, the heat exchanger may be a gas-to-gas heat exchanger. A gas-to-gas heat exchanger thus transports heat between the inlet conduit and the outlet conduit. Since there is air present in the system, using other media to enable the heat transfer would imply a need for additional components. Hence, a gas-to-gas heat exchanger is particularly suitable in this type of system. Also, a gas-to-gas heat exchanger can transfer heat with higher temperatures compared to e.g. a liquid, which liquid boils at temperatures above their boiling temperature. Still further, a gas-to-gas heat exchanger is able to exchange heat between the conduits in a single component.

According to an example embodiment, the outlet conduit may comprise a first outlet conduit portion and a second outlet conduit portion, the first outlet conduit portion connecting the outlet end of the fuel cell to the heat exchanger, and the second outlet conduit bypassing the heat exchanger and connects the outlet end of the fuel cell to the inlet side of the expander. An advantage is that the exhaust flow from the fuel cell can be provided either directly into the heat exchanger and/or bypassing the heat exchanger and solely be provided into the heat exchanger from the exhaust conduit. Preferably, and according to an example embodiment, the fuel cell system may further comprise a first valve arrangement arranged in the outlet conduit, the first valve arrangement being configured to controllably direct the exhaust flow from the cathode side to the first outlet conduit portion and/or to the second outlet conduit portion. Thus, the valve is controlled, preferably by a control unit as is described below, for directing the exhaust flow to the first and/or second outlet conduits.

According to an example embodiment, the first valve arrangement may comprise a first valve in the first outlet conduit portion, and a second valve arranged in the second outlet conduit portion. As an alternative, the first valve arrangement may be arranged as a three-way valve.

According to an example embodiment, the exhaust conduit may comprise a first exhaust conduit portion connecting the exhaust side of the expander to the heat exchanger, and a second exhaust conduit connecting the exhaust side of the expander to the ambient environment. Preferably, and according to an example embodiment, the fuel cell system may further comprise a second valve arrangement arranged in the exhaust conduit, the second valve arrangement being configured to controllably direct the exhaust flow from the exhaust side of the expander to the first exhaust conduit portion and/or to the second exhaust conduit portion. Hereby, the flow exhausted from the expander can be directed towards the ambient environment. This alternative can be advantageously implemented when no heat transfer is desired between the inlet and outlet conduits, or when a heat transfer has taken place at another position in the system and there is a desire to avoid a pressure drop. The second valve arrangement may be formed by two separately controlled valves or by a single three-way valve. The valve arrangement may be arranged to controllably prevent exhaust flow from the expander to reach the ambient environment.

According to an example embodiment, the fuel cell system may further comprise a control unit connected to the first valve arrangement and to the second valve arrangement, the control unit comprising control circuitry configured to determine a current operating mode for the vehicle, and control the first and second valve arrangements based on the current operating mode.

The control unit may include a microprocessor, microcontroller, programmable digital signal processor or another programmable device. The control unit may also, or instead, include an application specific integrated circuit, a programmable gate array or programmable array logic, a programmable logic device, or a digital signal processor. Where the control unit includes a programmable device such as the microprocessor, microcontroller or programmable digital signal processor mentioned above, the processor may further include computer executable code that controls operation of the programmable device.

The current operating mode may, for example, relate to steady state operation of the vehicle, increased power requirement for the fuel cell, vehicle start-up with a fuel cell having a temperature level below a predetermined threshold limit, i.e. a cold start operating mode.

According to an example embodiment, the fuel cell system may further comprise an air compressor arranged at the inlet conduit. The air compressor is advantageously increasing the pressure level of the intake air to levels suitable for the fuel cell. The air compressor also increasing the temperature level of the intake air.

According to an example embodiment, the inlet conduit may comprise a first inlet conduit portion and a second inlet conduit portion, the first inlet conduit portion connecting the air compressor to the heat exchanger, and the second inlet conduit portion bypassing the heat exchanger and connects the air compressor to the inlet end of the cathode side. Preferably and according to an example embodiment, the fuel cell system may further comprise a third valve arrangement arranged in the inlet conduit, the third valve arrangement being configured to controllably direct a flow of compressed air from the air compressor to the first inlet conduit portion and/or to the second inlet conduit portion. When the temperature level of the intake air does not need to be heated or cooled, the heat exchanger can be advantageously bypassed. In a similar vein, the heat exchanger can be bypassed when the outlet conduit is in no need of increasing/decreasing its temperature level, i.e. when no heat transfer from the inlet conduit to the outlet conduit is desired, and when pressure drops should be avoided in the heat exchanger.

According to an example embodiment, the air compressor may be connected to the expander and the fuel cell motor. Preferably, the air compressor is mechanically connected to the expander and the fuel cell motor by means of a compressor shaft. As an alternative, the fuel cell motor could be connected to the compressor by means of a first shaft, while the fuel cell motor is connected to the expander by means of a second shaft, where the first and second shafts are different shafts.

According to an example embodiment, the fuel cell system may further comprise an exhaust valve arrangement connected to the outlet conduit for controllably bypassing the exhaust flow from reaching the expander.

According to an example embodiment, the fuel cell system may further comprise at least one temperature sensor, the temperature sensor being arranged at the inlet conduit. According to an example embodiment, the at least one temperature sensor may be arranged between the heat exchanger and the inlet end of the cathode side.

According to an example embodiment, the at least one temperature sensor may be arranged between upstream the heat exchanger. Using temperature sensors is advantageous as the heat transfer between the inlet conduit and the outlet conduit can be controlled based on the measured temperature levels at different positions in the fuel cell system.

According to an example embodiment, the fuel cell system may further comprise a charge air cooler arranged in the inlet conduit. Preferably, and according to an example embodiment, the fuel cell system may further comprise a charge air cooler, the charge air cooler being arranged in the inlet conduit in fluid communication between the heat exchanger and the inlet end of the cathode side.

According to a second aspect, there is provided a method of controlling a fuel cell system of a vehicle, the fuel cell system comprising a fuel cell comprising an anode side and a cathode side, an expander connected to a fuel cell motor, a heat exchanger, an inlet conduit connected between an inlet end of the cathode side and the heat exchanger, and an outlet conduit arranged to supply an exhaust flow from an outlet end of the cathode side, the outlet conduit comprising a first outlet conduit portion and a second outlet conduit portion, wherein the first outlet conduit portion connecting the outlet end of the cathode side to the heat exchanger, and the second outlet conduit bypassing the heat exchanger and connects the outlet end of the cathode side to an inlet side of the expander, wherein the method comprises: determining a current operating mode for the vehicle, controlling the exhaust flow from the outlet end of the cathode side to be directed to the first outlet conduit portion or to the second outlet conduit portion based on the current operating mode.

Effects and features of the second aspect are largely analogous to those described above in relation to the first aspect.

According to a third aspect, there is provided a vehicle at least partially propelled by an electric traction motor, the electric traction motor being electrically connected to a fuel cell system according to any one of the embodiments described above in relation to the first aspect.

Effects and features of the third aspect are largely analogous to those described above in relation to the first aspect.

Further features of, and advantages will become apparent when studying the appended claims and the following description. The skilled person will realize that different features may be combined to create embodiments other than those described in the following, without departing from the scope of the present invention.

### BRIEF DESCRIPTION OF THE DRAWINGS

The above, as well as additional objects, features, and advantages, will be better understood through the following illustrative and non-limiting detailed description of exemplary embodiments, wherein:

FIG. 1 is a lateral side view illustrating an example embodiment of a vehicle in the form of a truck;

FIG. 2 is a schematic illustration of a fuel cell system according to an example embodiment,

FIG. 3 is a schematic illustration of a fuel cell system according to another example embodiment, and

FIG. 4 is a flow chart of a method of controlling the fuel cell system according to an example embodiment.

### DETAILED DESCRIPTION

The present invention will now be described more fully hereinafter with reference to the accompanying drawings, in which exemplary embodiments are shown. The invention may, however, be embodied in many different forms and should not be construed as limited to the embodiments set forth herein; rather, these embodiments are provided for thoroughness and completeness. Like reference character refer to like elements throughout the description.

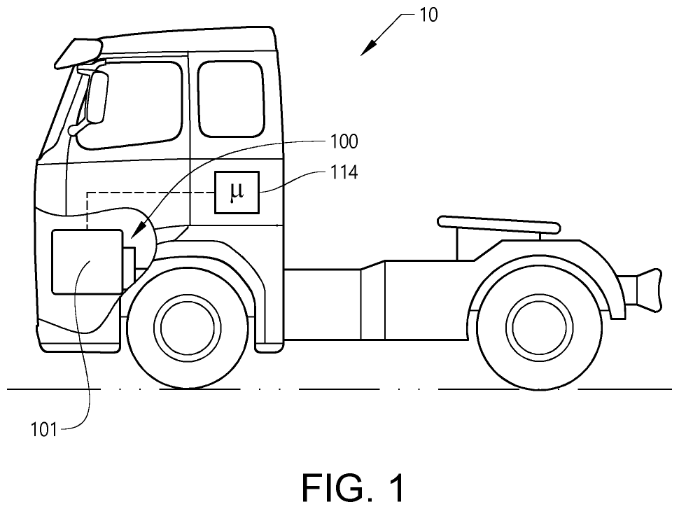

With particular reference to FIG. 1, there is depicted a vehicle 10 in the form of a truck. The vehicle comprises a traction motor 101 for propelling the wheels of the vehicle. The traction motor 101 is in the example embodiment an electric machine arranged to receive electric power from a battery or directly from a fuel cell system 100 which is described in further detail below. The vehicle 10 also comprises a control unit 114 for controlling various operations and functionalities as will also be described in further detail below.

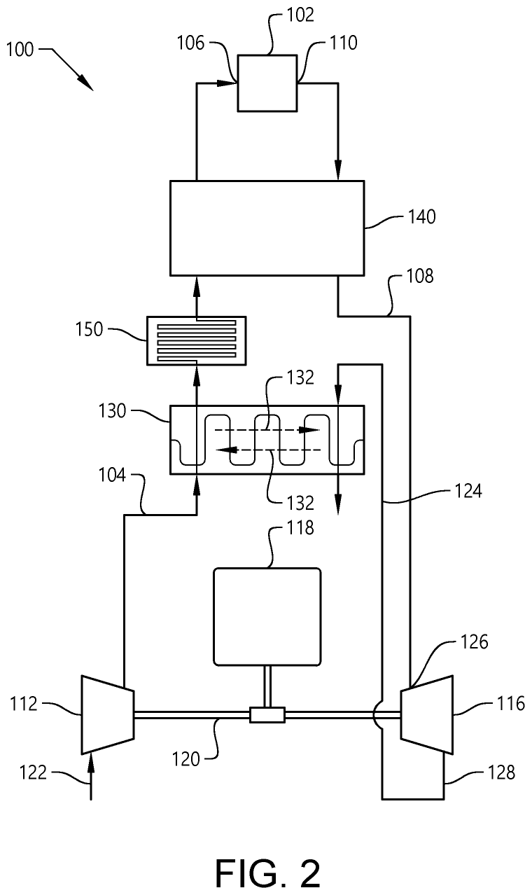

In order to describe the fuel cell system in further detail, reference is made to FIG. 2 which is a schematic illustration of a fuel cell system according to an example embodiment. The fuel cell system 100 comprises a fuel cell 102, also commonly referred to as a fuel cell stack. The fuel cell 102 may be composed of a more than one fuel cell, such as two fuel cells or a plurality of fuel cells. The fuel cell 102 is schematically illustrated an only depicts the cathode side, i.e. the anode side is omitted for simplifying the illustration. Other components could also be included in the fuel cell system but not depicted in FIG. 2, such as humidifier bypass and bypass of humidifier and stack, or valves.

The fuel cell system 100 further comprises an inlet conduit 104 connected to an inlet end 106 of the cathode side of the fuel cell 102. The inlet conduit 104 is arranged to supply air to the cathode side. The fuel cell system 100 also comprises an outlet conduit 108 connected to an outlet end 110 of the fuel cell 102 cathode side. Hereby, exhaust flow is supplied from the outlet end 110 of the fuel cell 102 and into the outlet conduit 108.

Furthermore, the fuel cell system 100 comprises an air compressor 112, an expander 116, and a fuel cell motor 118. Preferably, and according to the depicted example embodiment of FIG. 2, the air compressor 112, the expander 116 and the fuel cell motor 118 are mechanically connected to each other by means of a compressor shaft 120. Hence, the fuel cell motor 118 is arranged to control and operate the air compressor 112 and the expander 118. The air compressor 112 is arranged to receive, and pressurize ambient air 122. The pressurized ambient air is supplied to the inlet conduit 104, preferably via an air filter (not shown), and provided into the inlet end 106 of the fuel cell 102. The expander 116 is connected to the outlet conduit 108 and thus receives, and expands the exhaust flow from the outlet end 110 of the fuel cell 102. The air expanded from the expander 116 is supplied into an exhaust conduit 124 of the fuel cell system 100. The outlet conduit 108 is thus connected to an inlet side 126 of the expander 116, while the exhaust conduit 124 is connected to an exhaust side 128 of the expander 116.

The fuel cell system 100 further comprises a heat exchanger 130. The heat exchanger 130 is preferably a gas-to-gas heat exchanger and is connected between the inlet conduit 104 and the exhaust conduit 124. Hereby, a gas present in the heat exchanger 130 is configured to transfer heat, illustrated by the dashed lines numbered 132, between the inlet conduit 104 and the exhaust conduit 124.

As a further alternative, and as depicted in the exemplified embodiment, the fuel cell system 100 may also comprise a humidifier 140 connected to the inlet conduit 104 and the outlet conduit 106. The humidifier 140 is configured to transfer humidity from the outlet conduit to the inlet conduit. The humidifier may control the intake air as well as the exhaust flow from the fuel cell 102 at a desired humidity level. The fuel cell system 100 may also comprise an intercooler 150, such as a charge air intercooler, arranged in the inlet conduit 104. The intercooler 150 is preferably positioned in fluid communication between the heat exchanger 130 and the inlet end 106 of the fuel cell 102. When providing an intercooler 150 in combination with a humidifier 140, the intercooler 150 is preferably arranged in fluid communication between the heat exchanger 130 and the humidifier 140. The intercooler 150 is configured to controllably adjust the intake air before the intake air is supplied to the inlet end 106 of the fuel cell 102. The intercooler 150 is preferably, although not depicted in FIG. 2, connected to a cooling system of the vehicle 10.

By means of the example embodiment depicted in FIG. 2, ambient air 122 is received by the air compressor 112, preferably via a filter (not shown). The air compressor pressurizes the air and supplied the pressurized air towards the inlet end 106 of the fuel cell 102, where electric power is generated. The fuel cell 102 exhausts cathode exhaust through the outlet end 110 and into the outlet conduit 108. The exhaust flow is further directed into the expander 116, which expands the air and supplies the expanded air to the exhaust conduit 124. The pressurized air from the air compressor 112 and the expanded air from the expander 116 are also directed through the heat exchanger 130, for provided heat transfer between the inlet conduit 104 and the exhaust conduit 124.

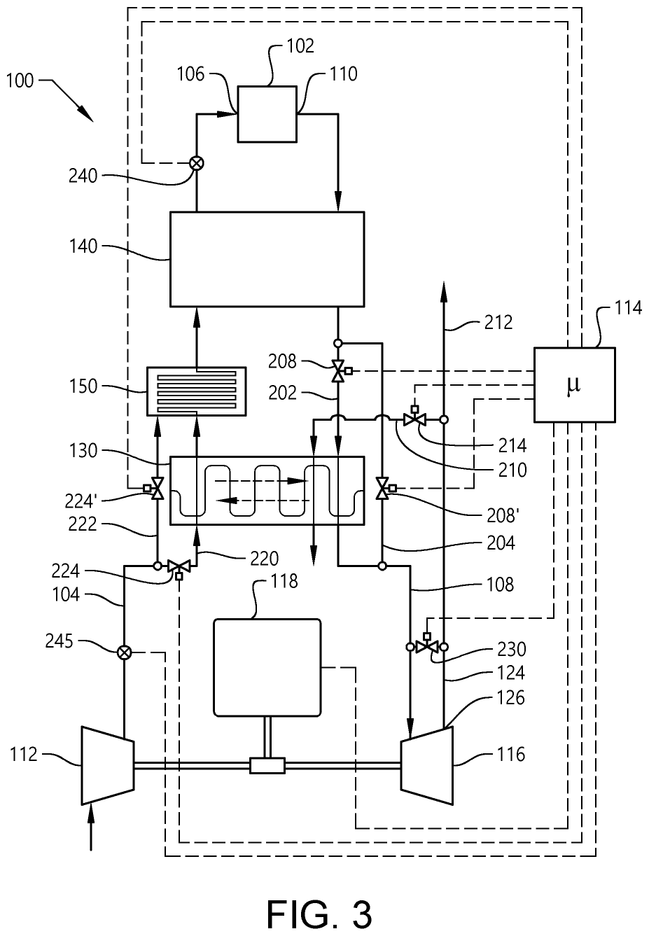

In order to describe a further detailed example embodiment of the fuel cell system 100, reference is made to FIG. 3, which is a schematic illustration of the fuel cell system according to another example embodiment. The fuel cell system in FIG. 2 and the fuel cell system in FIG. 3 shares many of the above described features and the following will therefore only describe the features in FIG. 3 that differs from the example embodiment of FIG. 2.

As can be seen in FIG. 3, the outlet conduit 108 comprises a first outlet conduit portion 202 connecting the outlet end 110 of the fuel cell 102 to the heat exchanger 130. The first outlet portion 202 is arranged through the heat exchanger 130 and arranged in fluid communication with the expander 116. Hereby, exhaust flow from the outlet end 110 of the fuel cell 102 can be directed into the heat exchanger 130 before reaching the expander 116. The outlet conduit 108 also comprises a second outlet portion 204 bypassing the heat exchanger 130. By means of the second outlet portion 204, the exhaust flow from the outlet end 110 of the fuel cell 102 can be directed to the expander 116 without passing the heat exchanger 130. The outlet conduit is thus formed by the first 202 and second 204 outlet conduit portions. In order to control the flow direction of exhaust flow from the outlet end 110 of the fuel cell 102, the fuel cell system 100 comprises a first valve arrangement 208, 208′ arranged in the outlet conduit 108. The first valve arrangement 208, 208′ thus controls the exhaust flow in the outlet conduit 108 to be directed into the heat exchanger 130 and/or to bypass the heat exchanger. The first valve arrangement 208′ is depicted as comprising a first valve 208 in the first outlet conduit portion 202, and a second valve 208′ in the second outlet conduit portion 204. The first valve arrangement 208, 208′ can however equally as well be arranged as a three-way valve positioned in the intersection between the first outlet conduit portion 202 and the second outlet conduit portion 204.

Furthermore, the exhaust conduit 124 comprises a first exhaust conduit portion 210 connecting the exhaust side 126 of the expander 116 to the heat exchanger 130.

The exhaust conduit 124 also comprises a second exhaust conduit 212 connecting the exhaust side 126 of the expander 116 to the ambient environment. Thus, expander air supplied from the expander into the exhaust conduit 124 can be controllably directed to the heat exchanger 130 and/or to the ambient environment. In order to control the flow direction of air from the expander 116, the fuel cell system 100 comprises a second valve arrangement 214 arranged in the exhaust conduit 124. Although the second valve arrangement 214 is depicted as positioned in the first exhaust conduit portion 210, it should be readily understood that the second valve arrangement 214 is, or can be, configured to prevent the flow of air from the expander to reach the ambient environment without passing the heat exchanger 130.

Moreover, the inlet conduit 104 comprises a first inlet conduit portion 220 connecting the air compressor 112 to the heat exchanger 130. The inlet conduit 104 also comprises a second inlet conduit portion 222 bypassing the heat exchanger 130. Hence, by means of the second inlet conduit portion 222, the pressurized air from the air compressor 112 can be directed to the inlet end 106 of the fuel cell 102 without passing the heat exchanger 130. In order to control the flow direction of pressurized air from the air compressor 112, the fuel cell system comprises a third valve arrangement 224, 224′ arranged in the inlet conduit 104. The third valve arrangement 224, 224′ is depicted as being formed by two individually controllable valves, but can also be formed by a single three-way valve, for example positioned in the intersection between the first 220 and second 222 inlet conduit portions.

Still further, the fuel cell system 100 exemplified in FIG. 3 comprises an exhaust valve arrangement 230 connected to the outlet conduit 108. The exhaust valve arrangement 230 is configured to controllably bypass the exhaust flow from reaching the expander 116. In FIG. 3, the exhaust valve arrangement 230 is arranged between the outlet conduit 108 and the exhaust conduit 124, but could also be arranged between the outlet conduit 108 and the ambient environment.

As is also depicted in FIG. 3, the fuel cell system 100 comprises temperature sensors 240, 245 arranged in the inlet conduit 104. The temperature sensors 240, 245 are arranged to determine the temperature level of the intake air before it reaches the fuel cell 102. In the exemplified embodiment of FIG. 3, the temperature sensors are formed by a first temperature sensor 240 arranged between the heat exchanger 130 and the inlet end 106 of the fuel cell 102, and a second temperature sensor 245 arranged upstream the heat exchanger 130, i.e. between the air compressor 112 and the heat exchanger 130. Although not depicted in FIG. 3, the fuel cell system may also contain temperature sensors in the fuel cell, or in a housing of the fuel cell. Hereby, the temperature level of the fuel cell can be determined.

As described above in relation to FIG. 1, the vehicle 10, and thus in turn the fuel cell system 100 comprises a control unit 114. As can be seen in FIG. 3, the control unit 114 is connected to each of the above described valve arrangements, the fuel cell motor, and the temperature sensors. The control unit 114 is thus configured to receive data indicative of the temperature level in the inlet conduit 104, control the different valve arrangements between open and closed positions, and receive operational data from the fuel cell motor 118, and control operation of the fuel cell motor 118. The control unit 114 may also be connected to a vehicle control system for receiving signals indicative of e.g. a current operating mode for the vehicle.

The following will now describe various example embodiments of how to control the flow of air in the above described fuel cell system 100. According to a first example embodiment, the vehicle is operated in a normal operating mode in which no additional power is required by the fuel cell 102 to generate electric power. In such a case, and when at least one of the temperature sensors 240, 245 transmits a signal to the control unit 114 indicative of a temperature level below a predetermined threshold limit, i.e. the intake air is in need of heating, the control unit 114 controls the first valve arrangement 208, 208′ to direct exhaust flow from the outlet end 110 of the fuel cell 102 to bypass the heat exchanger 130. Hence, exhaust flow is directed into the second outlet portion 204 and further directed to the expander 116. Also, the second valve arrangement 214 is arranged in a closed position so that air from the expander 116 is directed to the ambient environment and does not enter the heat exchanger 130. Further, the control unit 114 controls the third valve arrangement 224, 224′ to direct the pressurized air from the air compressor to bypass the heat exchanger 130, i.e. directed through the second inlet conduit portion 222.

On the other hand, when the at least one of the temperature sensors 240, 245 transmits a signal to the control unit 114 indicative of a temperature level above the predetermined threshold limit, i.e. the intake air is in need of cooling, the control unit 114 controls the first valve arrangement 208, 208′ to direct exhaust flow from the outlet end 110 of the fuel cell 102 through the heat exchanger 130. Hence, exhaust flow is directed into the first outlet portion 202 and further directed to the expander 116. Also, the second valve arrangement 214 is arranged in a closed position so that air from the expander 116 is directed to the ambient environment and does not enter the heat exchanger 130. Further, the control unit 114 controls the third valve arrangement 224, 224′ to direct the pressurized air from the air compressor through the heat exchanger 130, i.e. directed through the first inlet conduit portion 220.

According to another example embodiment, when the control unit 114 receives a signal indicative of a desire to increase power of the vehicle 10, the first valve arrangement 208, 208′ is controlled to direct exhaust flow from the outlet end 102 of the fuel cell 102 to bypass the heat exchanger 130, i.e. directed through the second outlet portion 204. The second valve arrangement 114 is arranged in an open position to direct the air from the expander 116 into the heat exchanger 130. Finally, the third valve arrangement 224, 224′ is controlled to direct the pressurized air from the air compressor through the heat exchanger 130, i.e. directed through the first inlet conduit portion 220. In this example, the heat exchanger 130 reduces the temperature level of the air entering the inlet end 106 of the fuel cell 102.

According to a further example embodiment, when the control unit 114 receives a signal indicative of starting operation of the vehicle 10, i.e. initiating operation of the fuel cell system 100, and when the inlet air is in need of increasing its temperature level, the control unit 114 controls the first valve arrangement 208, 208′ to direct exhaust flow from the outlet end 110 of the fuel cell 102 through the heat exchanger 130. Hence, exhaust flow is directed into the first outlet portion 202 and further directed to the expander 116. Also, the second valve arrangement 214 is arranged in a closed position so that air from the expander 116 is directed to the ambient environment and does not enter the heat exchanger 130. Further, the control unit 114 controls the third valve arrangement 224, 224′ to direct the pressurized air from the air compressor through the heat exchanger 130, i.e. directed through the first inlet conduit portion 220.

On the other hand, if the temperature level is too high during the starting operation, the control unit 114 controls the first valve arrangement 208, 208′ to direct exhaust flow from the outlet end 110 of the fuel cell 102 to bypass the heat exchanger 130. Hence, exhaust flow is directed into the second outlet portion 204 and further directed to the expander 116. Also, the second valve arrangement 214 is arranged in a closed position so that air from the expander 116 is directed to the ambient environment and does not enter the heat exchanger 130. Further, the control unit 114 controls the third valve arrangement 224, 224′ to direct the pressurized air from the air compressor to bypass the heat exchanger 130, i.e. directed through the second inlet conduit portion 222.

Based on the above, when the intake air needs to be cooled heat exchanger can be used to enable heat transfer from the inlet conduit to the outlet conduit and/or the exhaust conduit. Hereby, less cooling is needed in the various components of the fuel cell system 100 in order to achieve a desired temperature level of the air entering the fuel cell 102. This presents the advantageous effect of lowering the power consumption of the conventional components and therefore improving the fuel cell system 100 efficiency. This will in turn also lead to more energy available in the exhaust system. In detail, higher temperature of the exhaust enables for more energy to be extracted in the expander which contributes to an increased system efficiency. An increased temperature of the exhaust also enables air to have a higher water content before condensation, which is positive as ware on the expander due to water condensation can be avoided

In a situation where the intake air needs to increase its temperature level, the heat exchanger can be used for transferring heat from the outlet conduit and/or from the exhaust conduit to the inlet conduit. This would again lower the energy transfer needed from various components of the fuel cell system 100 to achieve the desired temperature of the air supplied to the inlet end of the fuel cell 102. In such a case, the heat exchanger 130 is preferably, and as described above, bypassed. The latter example is detailed above and advantageously implemented during a startup situation of the fuel cell 102 or during operation in cold climate. The temperature sensor(s) in the fuel cell can here provide an indication whether the fuel cell is in need of heating or not. For example, if a higher temperature on the fuel cell is desired, and the air after the compressor is lower than the fuel cell exhaust, a heat exchange is beneficial. On the other hand, if the temperature after the compressor is warmer than after the fuel cell, heat exchange is not wanted when the fuel cell temperature is lower than desired. If no heat exchange is present, heating would otherwise have to be supported from e.g. an electric heating system or other heating systems, which is less energy efficient. Hence, less battery capacity is needed, and a reduced number of components are necessary for the fuel cell system 100 to operate in the various operating modes.

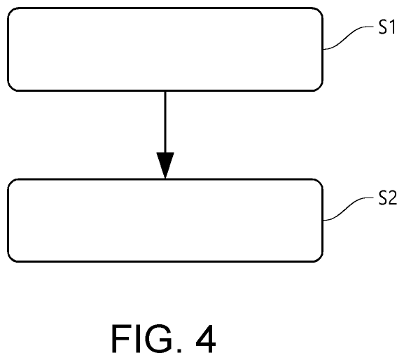

In order to sum up, reference is made to FIG. 4 which is a flow chart of a method of controlling the fuel cell system according to an example embodiment. During operation, the control unit 114 determines S1 a current operating mode for the vehicle 10. Detailed example embodiments of various operating modes are described above. Based on the current operating mode, the control unit 114 controls S2 the first 208, 208′ as well as the second 214 valve arrangements. Hence, the control unit 114 controls the flow of air from the fuel cell to be supplied directly from the outlet end of the fuel cell 102 to the heat exchanger, or supplied to the heat exchanger through the exhaust conduit 124. The control unit 114 may also control the third valve arrangement 224, 224′ to either direct the intake air through the heat exchanger 130 or to bypass the heat exchanger 130, i.e. direct the intake air from the air compressor to the inlet end 106 of the fuel cell 102 without passing the heat exchanger 130.

It is to be understood that the present disclosure is not limited to the embodiments described above and illustrated in the drawings; rather, the skilled person will recognize that many changes and modifications may be made within the scope of the appended claims.

1. A fuel cell system for a vehicle at least partially propelled by an electric traction motor, the fuel cell system comprising:
a fuel cell comprising an anode side and a cathode side,
an expander connected to a fuel cell motor,
an inlet conduit connected to an inlet end of the cathode side for supply of air to the cathode side, an outlet conduit connected between an outlet end of the cathode side and an inlet side of the expander for supply of an exhaust flow from the cathode side to the expander, and an exhaust conduit connected to an exhaust side of the expander, and
a heat exchanger connected at the inlet conduit and at the exhaust conduit for transfer of heat between the inlet conduit and the exhaust conduit.

2. The fuel cell system according to claim 1, wherein the heat exchanger is a gas-to-gas heat exchanger.

3. The fuel cell system according to claim 1, wherein the outlet conduit comprises a first outlet conduit portion and a second outlet conduit portion, the first outlet conduit portion connecting the outlet end of the fuel cell to the heat exchanger, and the second outlet conduit bypassing the heat exchanger and connects the outlet end of the fuel cell to the inlet side of the expander.

4. The fuel cell system according to claim 3, wherein the fuel cell system further comprises a first valve arrangement arranged in the outlet conduit, the first valve arrangement being configured to controllably direct the exhaust flow from the cathode side to the first outlet conduit portion and/or to the second outlet conduit portion.

5. The fuel cell system according to claim 4, wherein the first valve arrangement comprises a first valve in the first outlet conduit portion, and a second valve arranged in the second outlet conduit portion.

6. The fuel cell system according to claim 1, wherein the exhaust conduit comprises a first exhaust conduit portion connecting the exhaust side of the expander to the heat exchanger, and a second exhaust conduit connecting the exhaust side of the expander to the ambient environment.

7. The fuel cell system according to claim 6, wherein the fuel cell system further comprises a second valve arrangement arranged in the exhaust conduit, the second valve arrangement being configured to controllably direct the exhaust flow from the exhaust side of the expander to the first exhaust conduit portion and/or to the second exhaust conduit portion.

8. The fuel cell system according to claim 4, wherein the fuel cell system further comprises a control unit connected to the first valve arrangement and to the second valve arrangement, the control unit comprising control circuitry configured to:
determine a current operating mode for the vehicle, and
control the first and second valve arrangements based on the current operating mode.

9. The fuel cell system according to claim 1, wherein the fuel cell system further comprises an air compressor arranged at the inlet conduit.

10. The fuel cell system according to claim 9, wherein the inlet conduit comprises a first inlet conduit portion and a second inlet conduit portion, the first inlet conduit portion connecting the air compressor to the heat exchanger, and the second inlet conduit portion bypassing the heat exchanger and connects the air compressor to the inlet end of the cathode side.

11. The fuel cell system according to claim 10, wherein the fuel cell system further comprises a third valve arrangement arranged in the inlet conduit, the third valve arrangement being configured to controllably direct a flow of compressed air from the air compressor to the first inlet conduit portion and/or to the second inlet conduit portion.

12. The fuel cell system according to claim 9, wherein the air compressor is connected to the expander and the fuel cell motor.

13. The fuel cell system according to claim 1, wherein the fuel cell system further comprises an exhaust valve arrangement connected to the outlet conduit for controllably bypassing the exhaust flow from reaching the expander.

14. The fuel cell system according to claim 1, wherein the fuel cell system further comprises at least one temperature sensor, the temperature sensor being arranged at the inlet conduit.

15. The fuel cell system according to claim 14, wherein the at least one temperature sensor is arranged between the heat exchanger and the inlet end of the cathode side.

16. The fuel cell system according to claim 14, wherein the at least one temperature sensor is arranged between upstream the heat exchanger.

17. The fuel cell system according to claim 1, wherein the fuel cell system further comprises a charge air cooler, the charge air cooler being arranged in the inlet conduit in fluid communication between the heat exchanger and the inlet end of the cathode side.

18. A method of controlling a fuel cell system of a vehicle, the fuel cell system comprising
a fuel cell comprising an anode side and a cathode side,
an expander connected to a fuel cell motor,
a heat exchanger,
an inlet conduit connected between an inlet end of the cathode side and the heat exchanger, and
an outlet conduit arranged to supply an exhaust flow from an outlet end of the cathode side, the outlet conduit comprising a first outlet conduit portion and a second outlet conduit portion, wherein the first outlet conduit portion connecting the outlet end of the cathode side to the heat exchanger, and the second outlet conduit bypassing the heat exchanger and connects the outlet end of the cathode side to an inlet side of the expander,
wherein the method comprises:
determining a current operating mode for the vehicle,
controlling the exhaust flow from the outlet end of the cathode side to be directed to the first outlet conduit portion or to the second outlet conduit portion based on the current operating mode.

19. A vehicle at least partially propelled by an electric traction motor, the electric traction motor being electrically connected to a fuel cell system according to claim 1.
